(19) United States
(12) Patent Application Publication
(10) Pub. No.: US 2002/0164994 A1
(43) Pub. Date: Nov. 7, 2002

(54) Modular transponder

(75) Inventor: Per-Ola Lundberg, Skelleftes (SE)

Correspondence Address: PILLSBURY WINTHROP, LLP, P.O. BOX 10500, MCLEAN, VA, 22102, US

(73) Assignee: Followit AB

(21) Appl. No.: 09/815,254

(22) Filed: Mar. 22, 2001

(30) Foreign Application Priority Data
Feb. 28, 2001 (SE) 0100693-1

(51) Int. Cl. H04Q 7/20

(52) U.S. Cl. 455/456; 455/12.1; 455/41

(57) ABSTRACT

The invention relates to a method for the dynamic control of functions of a modular transponder (90) for positioning objects, and a modular transponder (90) for this purpose. The modular transponder consists of a number of units (10, 20, 30, 40, 50, 60, 80) that can be connected to one another in different ways to obtain a variety of applications for the transponder (90). For a user of the transponder (90) to be able to change application without possessing detailed knowledge of programming, the transponder (90) is configured by alphanumeric symbols being sent via data or SMS messages.

### TECHNICAL AREA The present invention relates to a method for the dynamic control of the functions of a modular transponder or positioning objects, and to modular transponder for this purpose.

### PRIOR ART

Through the satellite navigation system GPS (Global Positioning System), the position of an object that carries a receiver for GPS positioning can be determined. It is even common to integrate a mobile station for cellular network telecommunication with a GPS receiver in one unit. In this way, the reporting of a position via the cellular network can be forwarded to a receiving mobile station. The integrated unit can be located in a vehicle, for example, whereby a vehicle owner or other person can, when they wish, obtain information about where the vehicle is through receiving positioning indications via a telephone with a chosen telephone number.

One problem with transponders for positioning is that they are manufactured and sold as ready-made units for a predetermined use, i.e. they lack a modular function so that they can acquire a new function through changing the hardware of the unit with a simple turn of the hand.

Another problem with the transponders of today used for different application areas, e.g. to trace vehicles, people and to give an alarm, is that they must be programmed to perform certain functions during manufacture, e.g. to locate the position of a vehicle. Programming a transponder is achieved by a specialist or other expert within the area of technology. A user of a transponder thus has only limited opportunities to choose the application area for the transponder when purchasing it. It would thus be desirable for a user to themselves be able to set the application area for the transponder after purchase, even though the user does not have any experience of programming. If this were possible, the user would be able to change the application area of the transponder between that named above and several other unnamed applications without any special skills in programming.

A recurring problem with GPS positioning that is often pointed out is that the GPS sometimes loses the possibility to receive signals from satellites. The reasons can be that a car equipped with a GPS system drives into a garage or finds itself in a radio shadow in some other way. The reason can also depend on external factors, damage, or that the antenna ends up under another object that hinders radio waves from the satellite.

Sometimes there is also a need within certain applications/practical uses for information about an object other than just its position in longitude and latitude, such as ID, speed, direction, position, date and time. Today, this information is not used to specify different types of conditions.

Such a function of a general nature, filter intelligence, i.e. a way of providing information that is used in positioning, does have significance depending on the context of its use and on the prerequisites.

The problems named above regarding positioning of objects are solved by the present invention in accordance with that stated in the attached independent claims. Further embodiments of the invention are stated in the attached non-independent claims.

### SUMMARY OF THE DESCRIBED INVENTION

The present invention specifies solutions to, among other things, problems according to that named above for positioning objects such as things, people and animals. In this case, the present invention specifies a method for the dynamic control of the functions of a modular transponder for the positioning of objects, whereby a Main Unit for positioning consists of a satellite positioning and process control unit, a cellular mobile communication unit and a hardware interface for communicating with other application units that are connected.

The way of working of the connected units for positioning and communication configuration with external units is modular through the units named above being switchable with one another with a simple turn of the hand via an included connection interface for introducing a new type of application and is controlled by continuously changeable user variables that are sent as packets. The variables consist of alphanumeric symbols where each symbol has its equivalent in a binary code for digital communication. The configuration of the modular transponder is determined by a packet via a data or text message sent from an external communication arrangement, perhaps with a web interface, which allows the transponder to be manufactured and sold without its specific function being configured and adapted to the customer. The process control unit uses the digital equivalents of the alphanumeric symbols for configuring the transponder.

According to some embodiments, the present invention consists of additional units besides the Main Unit. One so-called application unit is an I/O unit for analog/digital communication with external units. Another application unit is a Battery unit. A further application unit is a Charging cable unit for connecting to the Battery unit and an external battery charger. Yet another application unit is an Audio cable unit that connects to an audio connection included in the Main unit, as well as to one of the units for I/O and battery. To adapt the units to certain prevailing levels of voltage, there is a Series unit/Serial unit application unit for adapting between CMOS voltage levels and RS232 voltage levels. In addition, there is an application unit in the form of a Cable unit for earth and suitable direct current. A further application unit is a Connecting cable unit for connecting the said units to a common data/control buss via a buss-input connection included in the units.

In one embodiment of the invention, the satellite positioning unit is a Global Positioning System unit or similar and the mobile communication unit is a unit that communicates via GSM or similar cellular mobile telecommunication system, plus that the data-text message is sent via GSM data respectively Short Message Services or similar.

In a further embodiment, the transponder has a memory unit for logging positioning data, whereby the transponder can, via the data-text message, be configured for the static memory storage of positional data in freely chosen time intervals and numbers of positions, whereby the transponder is triggered to transmit all stored positional data to an external unit for positional reporting when the memory capacity is fully utilized, and whereby this is repeated every time the memory becomes fully utilized.

In another embodiment, the transponder has a memory unit for logging positional data, whereby the transponder can, via the data-text message, be configured for the continual memory storage of a number of positions. The transponder replaces the stored positioning data in the memory unit according to the FIFO principle (First In, First Out).

Positional reporting to an external unit is achieved in one embodiment of the invention when the satellite-positioning unit loses the receipt of signals for positioning. Positioning continues when the satellite-positioning unit resumes receiving the signal.

In a further embodiment, the transponder is initiated to external positional reporting via the NMEA protocol (National Marine Electronic Association) or similar protocol when one of the parameters longitude/latitude, direction, time, date or speed falls below, exceeds or touches a configured value predetermined by the user.

In one embodiment, the transponder includes an IP-stack, which allows the transponder to function as a web server for direct communication with an open network for data and telecommunication.

In addition, the present invention specifies a modular transponder with dynamic control of functions for the positioning of objects, whereby a Main unit for positioning consists of a satellite-positioning and process control unit, a cellular mobile communication unit and a hardware interface for communicating with other application units that are connected. In this case, it additionally includes:

modularity through the units named above being switchable with one another via an included connection interface with a simple turn of the hand for introducing a new type of application;

the means of receiving in a mobile communciation unit for receiving control commands regarding the way of working of the connected units, which include user variables that can be continuously changed by the user and that are received as packets sent as data or text messages from an external communciations device, whereby the variables consist of alphanumeric symbols where each symbol has its equivalent in a binary code for digital communication;

an interface means for transforming the received alphanumeric symbols to their binary equivalents, which is equivalent to a configuration code that the controlling processor uses to control the configuration of the units in the transponder; and

that allows the transponder to be manufactured and sold without its specific function being configured and adapted to the customer, whereby a user configures the specific function by sending a data or text message to the transponder with an external communication device that may include a web browser.

In other embodiments of the invention, the Modular transponder includes the application units namned in the method.

In one embodiment of the invention, the satellite positioning unit is a Global Positioning System unit or similar and the mobile communication unit is a unit that communicates via GSM or similar cellular mobile telecommunication system, plus that the data-text message is sent via GSM data respectively Short Message Services or similar.

In a further embodiment, the transponder has a memory unit for logging positioning data, whereby the transponder can, via the data or text message, be configured for the static memory storage of positional data in freely chosen time intervals and numbers of positions. The modular transponder is triggered to transmit all stored positional data to an external unit for reporting positional data when the capacity for memory is fully utilized, and whereby this is repeated every time the memory is fully utilized.

In another embodiment, the modular transponder has a memory unit for logging positional data, whereby the transponder can, via the data or text message, be configured for the continual memory storage of a number of positions. The transponder replaces the stored positioning data in the memory unit according to the FIFO principle.

Positional reporting to an external communication device is achieved in one embodiment of the invention when the satellite positioning unit looses the receipt of signals for positioning, whereby positioning continues when the satellite positioning unit resumes receiving the signal.

In yet another embodiment of the present invention, the modular transponder is initiated to external positional reporting via the NMEA protocol or similar protocol when one of the parameters longitude/latitude, direction, time, date or speed exceeds or reaches a configured value predetermined by the user.

In one embodiment, the transponder includes an IP-stack, which allows the transponder to function as a web server for direct communication with an open network for data and telecommunication.

### BRIEF DESCRIPTION OF DRAWINGS

In the continuation of the descriptive text, reference is made to the attached figures for a better understanding of the present invention and its examples and embodiments given, whereby:

FIG. 1 illustrates one embodiment of a Main unit for a modular transponder according to the present invention.

FIG. 2 illustrates one embodiment of an I/O unit for a modular transponder according to the present invention.

FIG. 3 illustrates one embodiment of a Serial unit for a modular transponder according to the present invention.

FIG. 4 illustrates one embodiment of a Battery unit for a modular transponder according to the present invention.

FIG. 5 illustrates one embodiment of an Audio cable unit for a modular transponder according to the present invention.

FIG. 6 illustrates one embodiment of a Power supply cable unit for a modular transponder according to the present invention.

FIG. 7 illustrates one embodiment of a Charging cable unit for a modular transponder according to the present invention.

FIG. 8 illustrates one embodiment of a Buss cable connecting unit for a modular transponder according to the present invention.

FIG. 9 illustrates one embodiment of an application for a modular transponder according to the present invention.

FIG. 10 illustrates one embodiment of a further application for a modular transponder according to the present invention.

FIG. 11 illustrates schematically in block form an embodiment of how a modular transponder according to the present invention specifies positional information.

FIG. 12 illustrates schematically in block form how an external transmitter activates a modular transponder according to the present invention.

FIG. 13 illustrates schematically in block form a pre-initiation situation for a modular transponder according to the present invention.

FIG. 14 illustrates schematically a communication pathway including a modular transponder according to the present invention.

FIG. 15 illustrates schematically a second communication pathway including a modular transponder according to the present invention.

### Tables

The following tables can be found at the very end of the present description, whereby:

Table 1 shows an embodiment of an initiation with alphanumeric symbols of a modular transponder according to the present invention.

Table 2 shows alphanumeric symbols sent in a packet from a modular transponder according to the present invention.

Table 3 shows a termination with alphanumeric symbols of a modular transponder according to the present invention.

Table 4 shows a further embodiment of an initiation with alphanumeric symbols of a modular transponder according to the present invention.

Table 5 shows a further embodiment of alphanumeric symbols sent in a packet from a modular transponder according to the present invention.

Table 6 shows a further embodiment of a termination with alphanumeric symbols of a modular transponder according to the present invention.

Table 7 shows yet another embodiment of an initiation with alphanumeric symbols of a modular transponder according to the present invention.

Table 8 shows an embodiment of alphanumeric symbols sent in a packet during an ongoing call from a modular transponder according to the present invention.

Table 9 shows an embodiment of a termination with alphanumeric symbols of a modular transponder according to the present invention during an ongoing call.

### DETAILED DESCRIPTION OF PREFERRED EMBODIMENTS

The present invention relates to a method for the dynamic control of the functions of a modular transponder and to a modular transponder for this purpose. The modularity is one aspect of why the transponder does not need to be tailor-made or adapted to customers during its manufacture or prior to a sale. Another aspect of this constitutes that the transponder does not need to be programmed at manufacture or after purchase since it utilizes a new and innovative method for setting up these applications. Setting up a specific application can be achieved close to real-time or in real-time, i.e. the point in time when the application shall be initiated. This takes place through the modular transponder obtaining, via data or SMS messages, alphanumeric symbols with a binary number equivalent for digital communication. The symbol can, for example, belong to the ASCII code or other similar text code. In this case, the transponder is controlled by that the packet containing parameters of alphanumeric symbols is sent from an external communication device, for example, for cellular telecommunication, whose binary equivalents are interpreted by a processor in the transponder that controls the setting of the application in the transponder. The interpretation takes place so that software program in the transponder recognizes certain control symbols, ID, in the alphanumeric packet that was sent, after which the software program reads all the control symbols and sets up the transponder for the desired application according to the control symbols read, see Tables 1-9. The transponder is controlled so that it sends alphanumeric symbols to the communication device for specifying position, ID, speed, direction, date and time.

Communication device refers to all devices that can communicate with a transponder including a cellular radio part, for example, a mobile telephone, PC, laptop, PDA, etc., as well as computerized devices including a radio part for mobile telecommunication.

The alphanumeric symbols can be sent over a channel for cellular wireless data transmission or via a messaging system in a cellular mobile telecommunication system. Cellular mobile telecommunication system refers to such systems as GSM (Global System for Mobile communication), GPRS (General Packet Radio Service) and UMTS (Universal Mobile Telecommunication System), other similar TDMA, CDMA or WCDMA systems for wireless telecommunication. As such, neither is the present invention restricted to messaging systems such as GSM-SMS, as similar systems with other designations can be used for this purpose.

In addition, the message can be transferred to the modular transponder via an IP-stack, which means that the transponder functions as a web server and can in this way communicate directly with the Internet. The communication is achieved as previously, i.e. with a data transmission, while receiving takes place via TCP/IP.

The possibility of configuring the transponder according to the present invention through, for example, a SMS is also very useful when a user of it wants the transponder to be used for different things on different occasions. For example, a taxi company may want to monitor its vehicles via its operational center when they are in use and, when they are no longer operational, reconfigure the transponder to function as a theft alarm. This constitutes an example of a real-time configuration of an application for the transponder that permits a flexible adaptation to a current real working situation.

The units and other hardware included in the transponder are described below. The modular construction and function of the transponder according to the present invention allows a number of different applications and practical uses for the transponder.

In one embodiment of the present invention, the structure of the modular transponder is defined 8 separate units. The working name for the modular transponder is “Mobile Retrieval System”. The eight units, which will be described in greater detail below, are MRS unit (Main unit), MRS-I/O unit (I/O unit), MRS-Serial unit (Series unit), MRS-Battery unit (Battery unit), MRS-Audio cable unit (Audio cable Unit), MRS-Power supply unit (Power supply unit), MRS-Charging cable unit (Charging cable unit), and MRS-Connecting cable Unit (Connecting cable unit).

Each possible combination of these units includes at least one of the following unit combinations as the smallest component part:

Main unit+Connecting cable unit+Battery unit or

Main unit+Power supply unit

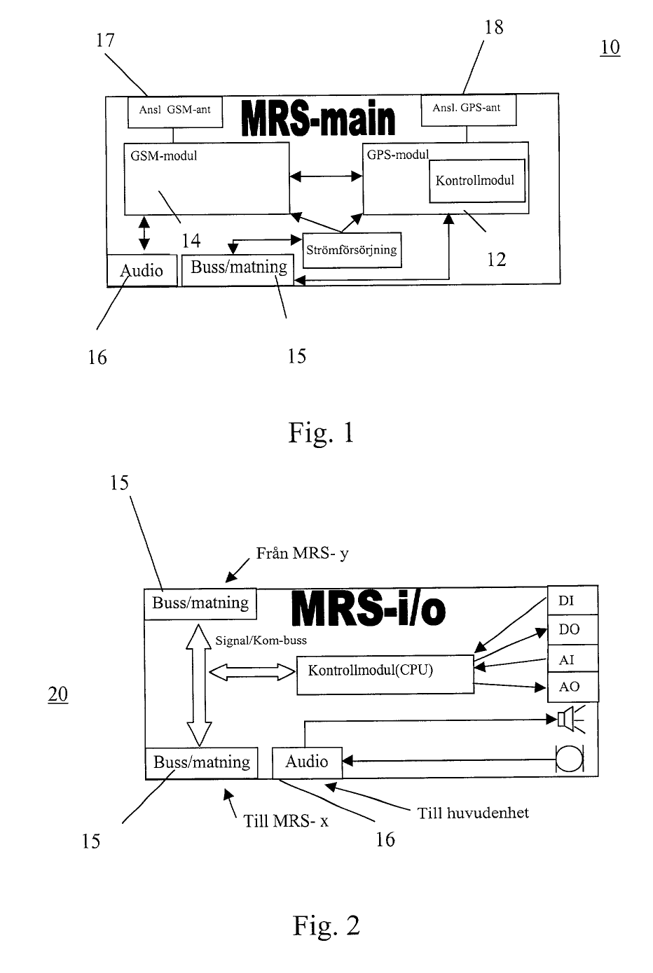

FIG. 1 illustrates an embodiment of a main unit 10 for a modular transponder according to the present invention. The Main unit 10 comprises a positioning/control module (GPS/CPU) 12, a communication module (GSM) 14 and associated adaptation hardware for the power supply to the respective modules.

In addition, Main unit 10 has a connection interface 15, 16, 17, 18 male/female, for connecting to external units according to that below. In one embodiment of the invention, a connection interface constitutes a contact 15 for buss and voltage input, a contact 17 for a GSM antenna connection and a contact 18 for a GPS antenna connection. Other units in the modular transponder according to that below have at least one of the connection interfaces 15, 16, 17, 18 according to that above.

A hardware interface is needed for the Main unit 10 to be coupled to and communicate with the remaining units in the system. In one embodiment, the interface includes a GND (earth), +3.6 VDC (incoming feed voltage from the Battery unit), +12 VDC (incoming feed voltage from an external power unit via the Power supply cable Unit 12VDC), Rx: RS232 “Receive” (receive with CMOS-compatible level), Tx: RS232 “Transmit” (transmit with CMOS-compatible level), MIC in: (Microphone input), LS out: (loudspeaker output) and connections for antennas (GSM and GSP antennas). The invention is not limited to the voltage levels named here; they merely constitute examples of common levels in this context.

These parts can be regarded as a consistent signal/data buss that will be found in every unit. For practical reasons, it is appropriate to divide the signals into two groups according to Buss/input and Audio:

Buss/input

1. GND

2. +3.6 VDC: incoming feed voltage from MRS-Battery.

3. +2 VDC: incoming feed voltage from an external power unit via MRS-cable 12 VDC.

4. Rx: RS232 “Receive”. Note! only CMOS-compatible level.

5. Tx: RS232 “Transmit”. Note! only CMOS-compatible level.

Audio

1. MIC in: Microphone input.

2. LS out: Loudspeaker output.

FIG. 2 illustrates an embodiment of an I/O unit 20 for a modular transponder according to the present invention. The unit comprises a process control unit (CPU) that processes all incoming and outgoing digital and/or analog signals that may arise. Examples of these signals are incoming signals from different transmitters: temperature transmitters, tachometers, movement detectors, etc., and outgoing signals to stepping motors, alarms, etc. Unit 20 communicates via the signals Rx and Tx in the defined interface with Main unit 10.

The I/O unit 20 can be connected further to the next unit in the different possibilities of combinations for the modular transponder according to the present invention. Unit 20 can be supplied with microphone and loudspeaker. It can even be connected to Main unit 10 via the Audio contact so that the microphone and loudspeaker can be utilized. The I/O unit 20 has inputs and outputs for digital and analog signals for reading sensor and transmitter values, see FIG. 2, DI (Digital In), DO (Digital Out), AI (Analog In, AO (Analog Out).

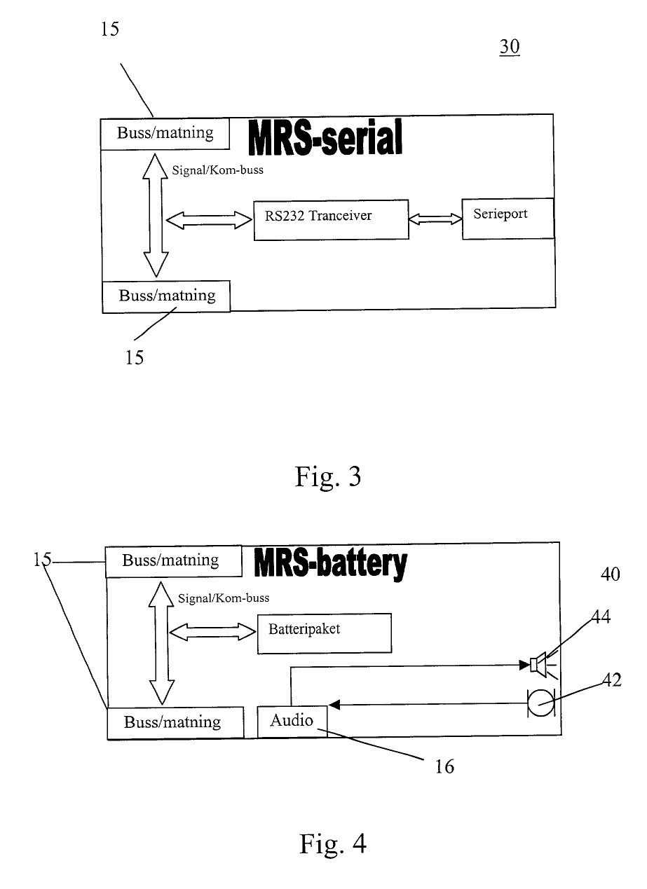

A further unit in the modular transponder according to the present invention constitutes the Serial unit 30, which is illustrated in FIG. 3. In one embodiment, this includes adaptation components between CMOS-levels and RS232-levels. An application area for unit 30 is to connect the Main unit 10 to a portable computer, PC or similar, for example.

Yet another unit in the modular transponder according to the present invention constitutes Battery unit 40 according to FIG. 4. The Battery unit supplies 3.6V and in one embodiment has a capacity of about 500 mAh. It can even be supplied with microphone 42 and loudspeaker 44. Unit 40 can then be connected to Main unit 10 via the Audio contact 16 so that the microphone and loudspeaker can be utilized.

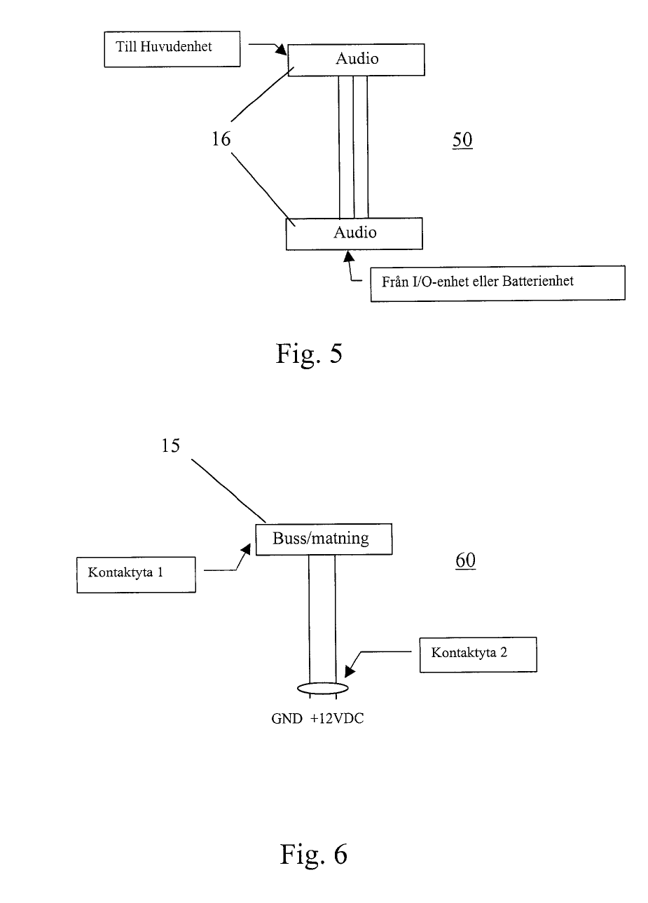

In one embodiment, the modular transponder also includes an Audio cable unit 50 according to FIG. 5. Unit 50 comprises a cable with 3 conductors for the MIC-input (microphone input), LS-output (loudspeaker) and earth. To be able to utilize the audio function in the Battery unit 40 and the I/O unit 20, the units are connected with the Main unit 10 partly via the Connecting-cable Unit (described in connection with FIG. 8 below) and partly via the Audio cable unit 50. To avoid voltage drop and picking up noise, unit 50 is supplied in a defined length.

In one embodiment according to FIG. 6, the modular transponder includes a Power supply cable unit 60. Unit 60 comprises a cable with 2 conductors for GND and +12 VDC. “Contact area 1” in FIG. 6 illustrates the interface with the other units in the modular transponder. “Contact area 2” illustrates the interface with an external power unit such as the electricity net, car electricity net. Contact area 2 or the contact have different appearances depending on where the transponder is installed.

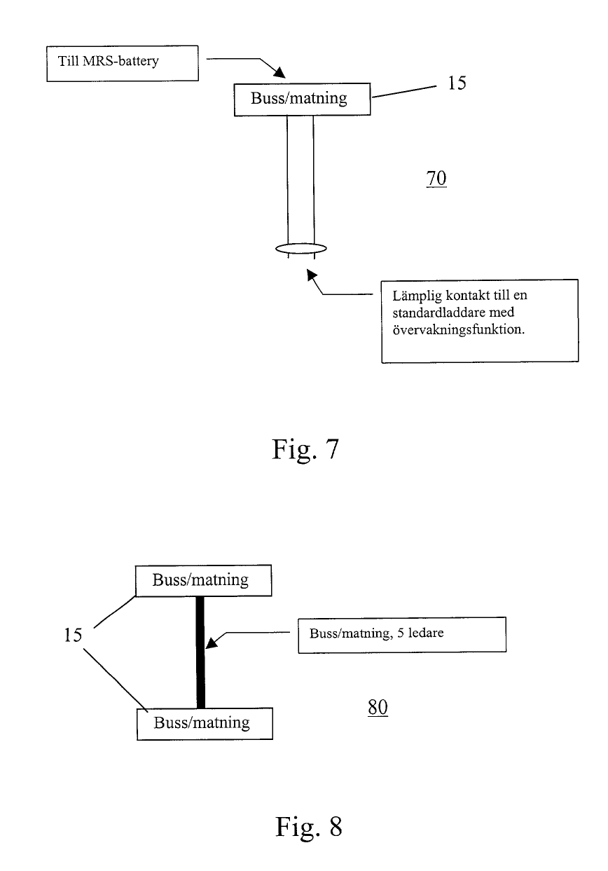

FIG. 7 illustrates schematically a Charging cable Unit 70 according to one embodiment of the modular transponder according to the present invention that comprises a cable with 2 conductors and that is used to couple the Battery unit 40 with a suitable charger with a supervision function.

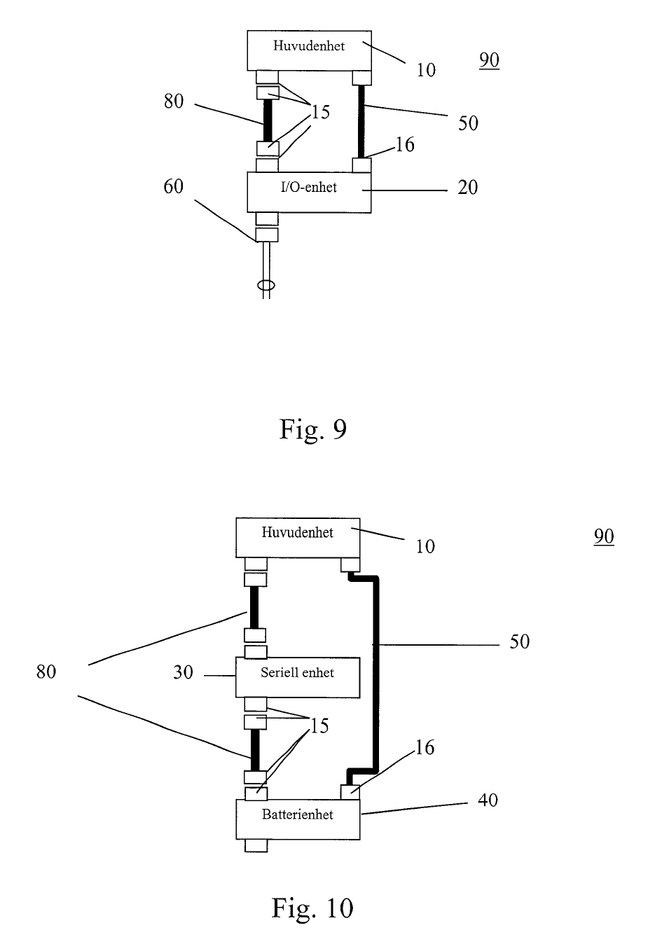

FIG. 8 illustrates a Cable connecting Unit 80 that comprises a cable with 5 conductors and that is used to couple different units for a modular transponder according to the present invention. The use of unit 80 is clearly evident from FIGS. 9 and 10.

FIG. 9 illustrates one embodiment of a practical use of a modular transponder 90 according to the present invention. From FIG. 9, it is evident how a modular transponder 90 can easily be configured from a hardware point of view by a user of the transponder to an application desired by the user by combining the units 10, 20, 30, 40, 50, 60, 80 that are included as building blocks in the modular transponder 90 according to the present invention. FIG. 9 shows a transponder with the Main unit 10 connected with an I/O unit 20 that gathers data from external sensors (not shown). The Main unit 10 and I/O unit 20 are connected to one another with the Cable-connecting Unit 80, and there is even an audio connection between units 10 and 20 via the Audio cable unit 50. The audio connection can be used for picking up external sound and transmitting an audible alarm. It can naturally also be used for spoken communication when the transponder 90 is used for positioning a person, for example. In addition, the transponder is connected to an external power supply via the Power supply cable unit 60. A transponder according to FIG. 9 can, among other things, be fitted to a vehicle for monitoring the vehicle.

FIG. 10 illustrates a further embodiment of a practical use of a modular transponder 90 according to the present invention. Here, transponder 90 is equipped with a battery to supply power and voltage via Battery unit 40. As the Battery unit 40 includes, among other things, CMOS circuits, Serial unit 30 functions as an interface for transforming to RS232 voltage levels. The RS232 protocol is one of the most common for external communication with a CPU and vice versa.

From FIGS. 9 and 10, it is evident how a user of transponder 90 can easily configure the hardware for a desired application by using the units 10, 20, 30, 40, 50, 60, 80. In FIG. 9, the desired application was related to the positioning of a vehicle, for example, and in FIG. 10, the transponder 90 could be used for positioning a person, for example. By connecting units with one another, a user can easily reconfigure the application area for transponder 90 and in this way avoid the need to purchase different ready-configured transponders for different purposes.

The configuration according to FIGS. 9 and 10 affects the hardware configuration. Below, it is described how configuration of the software is achieved by the user of transponder 90, without the user needing to know programming. With the help of units 10, 20, 30, 40, 50, 60, 80, plus configuring the software, transponder 90 according to the present invention constitutes a unique and flexible dynamic device where its application can be changed in real-time by a user with limited skills in technology or programming. In other words, it is customized to the needs of the customer by the customer after manufacture and sale.

Some modes/functions for how a transponder 90 according to the present invention should work and be configured are given below.

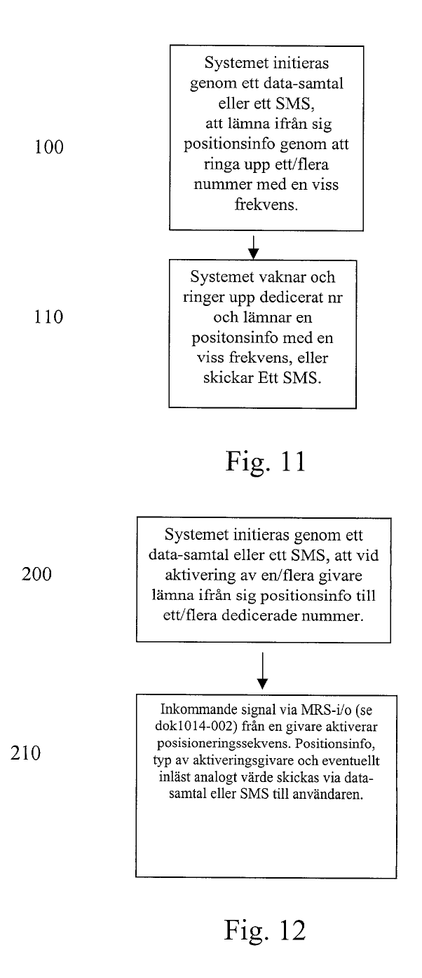

Mode 1 is identified here as a call received from transponder 90. In mode 1A, the transponder 90 is instructed to specify appropriate information about its position, speed, direction, ID, date and time with a predetermined regularity. The sequence of activities illustrates the function in mode 1A, which is evident from the block diagram in FIG. 11. The transponder 90 is initiated by a data transmission or a SMS to specify the positional information by calling one/several subscriber numbers with a predetermined regularity of calls 100. The transponder 90 then calls a dedicated/chosen number and specifies the positional information with a predetermined regularity by a data transmission or a SMS 110.

The user decides the regularity of an initiation or data transmission/SMS. Continued operation with data transmissions is confirmed at every call-up, otherwise the operation is terminated. The user can also terminate the operation and set the transponder 90 in the pre-initiation status with a new SMS message.

In mode 1B, an external influence is specified as a condition for calling up from the transponder 90, i.e. it is instructed to activate by an external transmitter. This operational situation is used in applications where the transponder 90 is used for surveillance purposes, for example. FIG. 12 illustrates the mode/function in this operational situation. Transponder 90 is initiated to call-up by a data transmission or a SMS, to specify positional information to one or more dedicated/chosen subscriber numbers 200 when one or more external sensors/transmitters are activated. A signal incoming via the I/O unit 20 from a transmitter activates a positioning sequence. Positional information, the type of activating transmitter and possibly the analog transmitter value read in are sent 210 via a data transmission or a SMS to the user of transponder 90.

Each call with positional information means that a reply from the user is initiated, for example, according to the following:

Reset transmitter, continue in the same operational mode

Go to the pre-initiation state

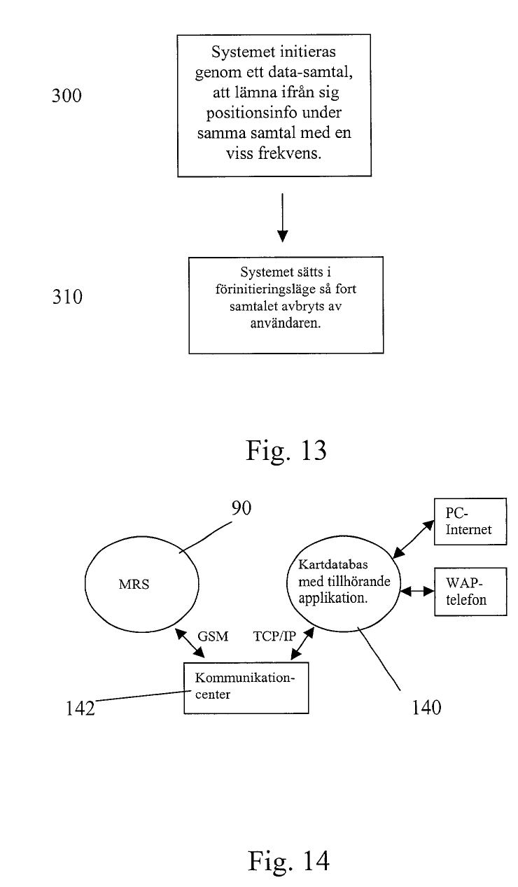

In a mode 2, the transponder 90 receives a call. In this case, the transponder 90 is instructed to specify appropriate information about its position, speed, direction, date and time during an ongoing call. When the call is terminated, the transponder 90 is set in its pre-initiation state. This is illustrated by the block diagram in FIG. 13.

The transponder 90 is initiated by a data transmission or a SMS to specify positional information during the actual call with a predetermined regularity 300. The transponder 90 is put in the pre-initiation state as soon as the call is cut off by the user 310. This operational situation is suitable for real-time applications where the user utilizes the transponder 90 in combination with GIS (Geographic Information System) applications.

In a system where a transponder is used for positioning objects, there is are limitations that need to be solved. One problem is due to the fact that while the GSM network has expanded more and more during recent years, there are still areas where the GSM signal coverage does not exist, which means that positional information from GPS receivers cannot be forwarded when GSM signal coverage is lacking. A solution to this problem is achieved by storing the positional information in the internal memory of the transponder for reading when requested by a user when the modular transponder according to the present invention once again finds itself in an area where there is GSM signal coverage.

Another problem is due to the fact that calculating position in a GPS receiver takes place via an advanced calculation of information received from specific satellites in orbits around the earth. The antenna of the GPS receiver must therefore always have an unrestricted view of the sky.

FIG. 14 clarifies schematically a communications link that includes a transponder 90 according to the present invention. As mentioned previously, MRS (Mobile Retrieval System) is a working name for transponder 90 and is synonymous with the modular transponder according to the invention. FIG. 14 shows via the arrows that point in both directions how a user communicates with the transponder/MRS 90 via a PC and Internet or a WAP telephone (Wireless Application Protocol) and Internet with a portal 140, which gives access to an Internet positioning service, here a map database, with an application that shows where the transponder/MRS is located. The user then communicates with an operations center 142 or a communications center that offers the Internet service, whereby the transponder/MRS 90 is asked from the center for details regarding positional information.

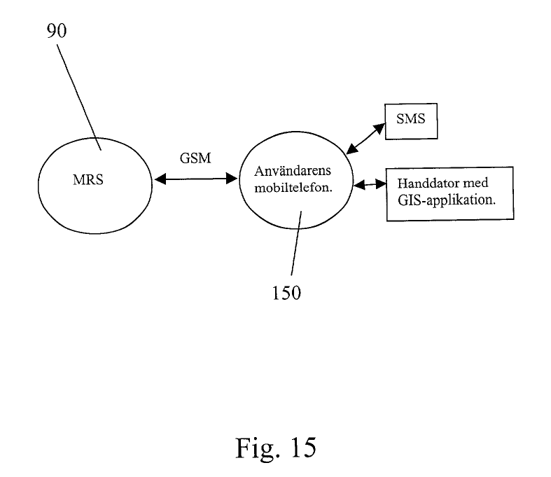

A further communication link where a transponder/MRS 90 according to the present invention is used is illustrated in FIG. 15. Here, the portable computer 150 (e.g. laptop), PDA (Personal Digital Assistant) or similar of a user, with a GIS application, is in communication with a transponder/MRS 90 via SMS. The user of a platform of the transponder 90 (here a PDA) can constitute a PDA that is connected to Internet and the applications that are offered via the Internet, but the PDA can also include an application installed locally in the PDA. Through a software program in the portable computer 150, the positional information of the SMS message, for example, be transformed to a marking on a map in the GIS application, or clarified for a user by some other appropriate means.

The modular transponder with dynamic control of functions for the positioning of objects according to the present invention has a Main unit 10 for positioning that consists of a satellite positioning and process control unit 12, a cellular mobile communication unit 14 and a hardware interface for communicating with other application units that are connected.

It additionally includes:

modularity through the above named units 10, 20, 30, 40, 50, 60, 80, being reversibly connectable with one another with a simple turn of the hand via a user interface that is included for introducing a new application;

the means of receiving in a mobile communciation unit for receieving control commands regarding the way of working of the connected units, which includes user-variables that can be continuously changed by the user and that are received in packets sent as data or text messages from an external communciations device, whereby the variables consist of alphanumeric symbols where each symbol has its equivalent in a binary code for digital communication;

interface means for transforming the received alphanumeric symbols to their binary equivalents, which is equivalent to a configuration code that the controlling processor uses to control the configuration of the units in the transponder; and

that allows the transponder to be manufactured and sold without its specific function being configured and adapted to the customer, whereby a user configures the specific function by sending a data or text message to the transponder with an external communication device.

As has been mentioned, the modularity of the transponder 90 according to the present invention constitutes one of the characteristics that make it easy for a user to themselves configure easily the transponder 90 to a desired application, e.g. an alarm transmitter, vehicle positioner, etc., with a simple turn of the hand. Another characteristic that makes it possible for a user to be able to configure the transponder 90 is that the user does not need special programming skills for the configuration. This characteristic is provided to the present invention via transmitting alphanumeric symbols that have a binary code for each symbol, e.g. ASCII code. The computer interface that processes the code is adapted to recognize standard codes such as ASCII (American Code Standard for Information Interchange) and does thus not need a specific software program for transforming codes.

For the sake of clarity, a brief description of the ASCII code follows here. ASCII is probably the most popular coding procedure used in PCs, for example, to transform letters, numbers, punctuation and control codes to digital form. The codes are recognized and understood by computers and other communication instruments when they have once been defined. A lower-case “C” has, for example, the binary code 1000011 and the number “3” has the code 010011. It has been developed by ANSI (American National Standards Institute) and allows practically all computers to “talk” with one another via modem or cable when the computers speak with the same speed.

By specifying alphanumeric symbols in variables that are sent as packets to the transponder via a data transmission or SMS, the user can easily configure the transponder 90 so that a desired application is obtained. A certain order of the symbols in a packet gives a digital code that the CPU in the Main unit 10 uses to control the transponder to execute at least a part of the application for a transponder 90.

In the present description, there are nine tables 1-9 that exemplify how a user can configure the transponder 90 with alphanumeric symbols. The tables can be found last in the description. The tables can be used as a template for a simple configuration in real-time of the transponder 90. They are practically self-explanatory, but for the sake of clarity, the rows and columns are explained.

In a mode 1 that is described in Table 1, an embodiment of an initiation of the transponder 90 according to the present invention is illustrated. The following packet is used to initiate the transponder 90: 2aBs,1,S,3600,A,200,N,00 +46910711500,00+46910711504\r\n. The packet is divided into variables that can include different parameter variables. The “name” column in Table 1 specifies the designation of the variables. For the packet above, the variables are separated by the comma sign and have, in order of turn, the names, see Table 1, the Unit ID, MODE-name, communication pathway, Interval, Termination/change, Number of calls, Log-function, Telephone no. 1, Telephone no. 2, <CR><LF>. As examples, the variables have been given the codes in the form of alphanumeric symbols that can be found in order of turn in the packet above.

In mode 1, a reply from a transponder 90, a packet from the transponder, can have an appearance in the form of alphanumeric symbols as follows, see also Table 2:

ID:2aBs<CR>

LAT:3723.2475,N<CR>

LON:12158.3416,W<CR>

SPEED:0.13 km/h<CR>

COURSE:309.63<CR>

TIME:161229.487<CR>

DATE:120598<CR>

A termination according to mode 1 can have the following appearance, see also Table 3:

2aBsTERM\r\n

In a mode 1B, the transponder 90 is initiated according to the following, see also Table 4:

2aBs,1A,S,E6,A,200,N00+46910711500,00+46910711504\r\n

In a mode 1B for the transponder 90, a packet is transmitted from it, see Table 5 for an interpretation of the symbols:

2aBs,1A,S,40,$GPRMC,161229.487,A,3723.2475,N,12158.3416,W,0.13,309.63,120598,*10\r\n

In Table 5, it is evident that speed and directional information is obtained for a vehicle, see Sections 12 and 13 in Table 5. In embodiments of the present invention, such information can be used to signal an alarm. The alarm can mean that the vehicle is stolen if it is not within a certain geographical area, or is on the way to such an area. The speed of a vehicle can also mean that it is stolen, i.e. the transponder 90 can signal an alarm if a certain predetermined speed if reached or exceeded. Another area of use for an alarm that is regulated by speed is the loaning out of a car for driving lessons on the condition that the speed does not exceed 110 km/h, for example. If the speed is exceeded, the transponder sends an alarm to an external receiver.

The NMEA protocol supplies (from the GPS unit) information about ID, speed, direction, position, date and time. The functionality in the transponder 90 permits time, position (longitude and latitude), direction and speed to be used as conditions for initiating the transponder 90. The values (for example, speed 60 km/h, direction 43 degrees or Lat 5741 Lon 1159), that are specified determine when the transponder is initiated for supplying positional data. The possibility also exists to specify an upper and a lower value for Lat and Lon, i.e. if the vehicle moves to outside <Lat 5741 and >5641 plus <1259 and >1159, this can be confirmed via, for example, a SMS.

Table 6 illustrates a termination for mode 1B with the following packet for transmitting to the transponder 90:

2aBsTERM\r\n

In a further mode 2 according to Table 7 in an embodiment for initiating the transponder 90, the following packet is sent to the transponder 90:

2aBs,3,05 \r\n.

Table 8 illustrates a mode 2 for receiving a packet from the transponder 90 where the packet in this mode is sent during an ongoing call with the transponder 90, whereby the following packet with alphanumeric symbols is sent to the communication device of a user:

$GPRMC,161229.487,A,3723.2475,N,12158.3416,W,0.13,309.63,120598,*10\r\n.

Table 9 illustrates a termination for mode 2 during an ongoing call, whereby the following packet is sent to the transponder 90:

2aBsTERM\r\n.

According to some innovative embodiments of the present invention, the log for positioning of the transponder can be managed in a novel way within the area of technology. By creating log files and using them in a manner according to the present invention, it is possible to solve the problem associated with radio shadows and other breaks in transmission between transponder and an external unit and vice versa. If the automatic function is not used and an attempt is nevertheless made to position an object, but without a position being obtained, it is possible to request information about the latest position “if we know into which building a vehicle was driven, we also know where it is”, through the log. Advantages also reside in that it is cheaper to send packets that include a number of different positions than to send each position individually. This offers greater opportunities to motivate economically different types of surveillance situations and logistics solutions.

In the log function according to the present invention, there is the functionality to store positional data in the memory of the transponder 90 in order to subsequently be able to request data for presentation. There are two alternatives for storing and distributing data:

Static memory storage. When the memory is full, the positions are sent as packets (SMS or GSM data) to the receiver. The storage in memory then continues until the memory once more becomes full, following which a new packet is sent. The time interval for the positioning can be freely chosen, as can the number of storages desired in memory.

Continuous memory storage. The positions are stored until the memory becomes full, following which the first position stored is over-written by the last stored, etc. The time interval for the positioning can be freely chosen. This memory constitutes a re-circulating memory. When the memory is full, the FIFO principle (First In First Out) is, for example, used for refilling a full memory.

The positions in the two cases above can be sent to an external receiver under two different assumptions:

The positions are sent in packets (SMS or GMS data) to the receiver on request.

The positions are sent in packets (SMS or GMS data) to the receiver when the GPS looses reception during a certain time that the user can define. The positioning continues when the GPS unit resumes reception.

The present invention is not restricted to the embodiments described here and the exemplifications. Instead, it is the wording of the attached claims that provides further embodiments for a person skilled in the art within the area of technology.

TABLE 2

| | | | o. | |
|---|---|---|---|---|
| Part | Name | Example | ymbols | Description |
| 1 | Unit ID | ID:2aBs<CR> | | ID: Four symbol id, |
| | | | | each can be a-z or A-Z |
| | | | | or 0-9, i.e. 11316496 |
| | | | | different combinations. |
| 2 | Latitude, North/south | LAT:3723.2475 | 6 | LAT:ddmm.mmmm,n/s |
| | indication | ,N<CR> | | |
| 3 | Longitude | LON:12158.34 | 7 | LON:dddmm.mmmm,e/ |
| | | 16,W<CR> | | w |
| 4 | Speed | SPEED:0.13 km | 4 | Unit: km/h. |
| | | /h<CR> | | |
| 5 | Direction | COURSE:309.6 | 4 | Unit: degrees. |
| | | 3<CR> | | According to “WGS84 |
| | | | | Earth-centered |
| | | | | Reference System” |
| 6 | UTC time | TIME:161229.4 | 6 | Coordinated Universal |
| | | 87\r | | Time (UTC) |
| 7 | Date | DATE:120598 | 1 | DATE:ddmmyy |
| | | <CR> | | |
| 8 | <CR><LF> | | | Final sequence, |
| | | | | “Carriage return Line |
| | | | | feed” |

TABLE 3

| | | | No. | |
|---|---|---|---|---|
| Part | Name | Example | symbols | Description |
| 1 | Unit ID | 2aBs | 4 | Four symbols, each can |
| | | | | be a-z or A-Z or 0-9, |
| | | | | i.e. 11316496 different |
| | | | | combinations. |
| 2 | Termination string | | 4 | TERM |
| 3 | <CR> <LF> | | 2 | Final sequence, |
| | | | | “Carriage return Line |
| | | | | feed” |

TABLE 4

| | | | No. | |
|---|---|---|---|---|
| Part | Name | Example | symbols | Description |
| 1 | Unit ID | 2aBs | 4 | Four symbols, each |
| | | | | can be a-z or A-Z or 0- |
| | | | | 9, i.e. 11316496 |
| | | | | different combinations. |
| 2 | “MODE”-name | 1B | 2 | |
| 3 | Communication | S | 1 | S = SMS, D = data |
| | pathway | | | MRS sends its packets |
| | | | | to users via SMS eller |
| | | | | data transmission. |
| 4 | Transmitter input | E6 | 2 | For example, E6 |
| | | | | means: 11100110 i.e. |
| | | | | transmitter inputs |
| | | | | 2,3,6,7,8 are activated. |
| 8 | Termination/change | A | 1 | S SMS, A Auto, D |
| | | | | Data. This symbol |
| | | | | shows in which way |
| | | | | the user will terminate |
| | | | | or change the operation |
| | | | | of the unit. |
| 9 | No. of calls | 200 | 3 | 1-999, if A above is |
| | | | | chosen. |
| 10 | Log-function | Y | 1 | Y yes, N no, Log |
| | | | | functionen activated or |
| | | | | not. |
| 11 | Telephone no. 1 | +xxxxxx | 14 | + and 14 numbers: 3 |
| | | xxxxxxx | | country code, 3 area |
| | | | | code, 7 subscriber no. |
| 12 | Telephone no. 2 | +xxxxxx | 14 | -“- |
| | | xxxxxxx | | |
| 13 | Check sum | *10 | 3 | |
| 14 | <CR><LF> | | 2 | Final sequence, |
| | | | | ”Carriage return Line |
| | | | | feed” |

TABLE 5

| | | | No. | |
|---|---|---|---|---|
| Part | Name | Example | symbols | Description |
| 1 | Unit ID | 2aBs | 4 | Four symbols, each can |
| | | | | be a-z or A-Z or 0-9, i.e. |
| | | | | 11316496 different |
| | | | | combinations. |
| 2 | “MODE”-name | 1A | 2 | |
| 3 | Communication | S | 1 | S = SMS, D = data |
| | pathway | | | MRS sends its packets to |
| | | | | users via SMS eller data |
| | | | | transmission. |
| 4 | Transmitter input | 40 | 2 | For example, 40 means: |
| | | | | 01000000 i.e. transmitter |
| | | | | input 7 is activated. |
| 5 | NMEA message ID | $GPRMC | 6 | Protocol head message |
| | | | | type RMC (see document |
| | | | | Protocol Specification) |
| 6 | UTC time | 161229.487 | 10 | Coordinated Universal |
| | | | | Time (UTC) |
| 7 | Status | A | 1 | A:GPS-data valid, |
| | | | | V:GPS-data not valid. |
| 8 | Latitude | 3723.2475 | 9 | ddmm.mmmm |
| 9 | North/south | N | 1 | N = north, S = south |
| | indicator | | | |
| 10 | Longitude | 12158.3416 | 10 | dddmm.mmmm |
| 11 | East/west indicator | W | 1 | E = east, W = west |
| 12 | Speed | 0.13 | 4 | Unit:knots. Possible |
| | | | | conversion occurs at the |
| | | | | user. Max speed 1000 |
| | | | | knots |
| 13 | Direction | 309.63 | 6 | Unit:degrees. |
| | | | | According to “WGS84 |
| | | | | Earth-centered Reference |
| | | | | System” |
| 14 | Date | 120598 | 6 | ddmmyy |
| 15 | Magnetic variation | | 1 | Unit:degrees |
| | | | | Note! Not applied. |
| | | | | 1 space between. |
| 16 | Check sum | *10 | 3 | See explanation |
| 17 | <CR><LF> | | 2 | Final sequence, “Carriage |
| | | | | return Line feed” |

TABLE 6

| | | | No. | |
|---|---|---|---|---|
| Part | Name | Example | symbols | Description |
| 1 | Unit ID | 2aBs | 4 | Four symbols, each can |
| | | | | be a-z or A-Z or 0-9, |
| | | | | i.e. 11316496 different |
| | | | | combinations. |
| 2 | Termination string | | 4 | TERM |
| 3 | Check sum | *10 | 3 | |
| 4 | <CR><LF> | | 2 | Final sequence, |
| | | | | “Carriage return Line |
| | | | | feed” |

TABLE 7

| | | | No. | |
|---|---|---|---|---|
| Part | Name | Example | symbols | Description |
| 1 | Unit ID | 2aBs | 4 | Four symbols, each can |
| | | | | be a-z or A-Z or 0-9, |
| | | | | i.e. 11316496 different |
| | | | | combinations. |
| 2 | “MODE”-name | 3 (NOTE!) | 1 | |
| 3 | Interval | 05 | 2 | ss Interval in seconds. |
| | | | | Max 99. |
| 4 | <CR><LF> | | 2 | Final sequence, |
| | | | | “Carriage return Line |
| | | | | feed” |

TABLE 8

| | | | No. | |
|---|---|---|---|---|
| Part | Name | Example | symbols | Description |
| 1 | NMEA message ID | $GPRMC | 6 | Protocol head message |
| | | | | type RMC (see |
| | | | | document Protocol |
| | | | | Specification) |
| 2 | UTC time | 161229.487 | 10 | Coordinated Universal |
| | | | | Time (UTC) |
| 3 | Status | A | 1 | A:GPS-data valid, |
| | | | | V:GPS-data not valid. |
| 4 | Latitude | 3723.2475 | 9 | ddmm.mmmm |
| 5 | North/south indicator | N | 1 | N = north, S = south |
| 6 | Longitude | 12158.3416 | 10 | dddmm.mmmm |
| 7 | East/west indicator | W | 1 | E = east, W = west |
| 8 | Speed | 0.13 | 4 | Unit:knots. Possible |
| | | | | conversion occurs at the |
| | | | | user. Max speed 1000 |
| | | | | knots |
| 9 | Direction | 309.63 | 6 | Unit:degrees. |
| | | | | According to “WGS84 |
| | | | | Earth-centered |
| | | | | Reference System” |
| 10 | Date | 120598 | 6 | ddmmyy |
| 11 | Magnetic variation | | 1 | Unit:degrees |
| | | | | Note! Not applied. |
| | | | | 1 space between. |
| 12 | Check sum | *10 | 3 | |
| 13 | <CR><LF> | | 2 | Final sequence, |
| | | | | “Carriage return Line |
| | | | | feed” |

TABLE 9

| | | | No. | |
|---|---|---|---|---|
| Part | Name | Example | symbols | Description |
| 1 | Unit ID | 2aBs | 4 | Four symbols, each can |
| | | | | be a-z or A-Z or 0-9, |
| | | | | i.e. 11316496 different |
| | | | | combinations. |
| 2 | Termination string | TERM | 4 | |
| 3 | <CR><LF> | | 2 | Final sequence, |
| | | | | “Carriage return Line |
| | | | | feed” |

1. Method for the dynamic control of functions in a modular transponder (90) for positioning objects, whereby a Main Unit (10) for positioning consists of a satellite-positioning and process control unit (12), a cellular mobile communications unit (14) plus a hardware interface for communicating with other connected application units (10, 20, 30, 40, 50, 60, 70, 80) characterized in that the way of working of the connected (10, 20, 30, 40, 50, 60, 70, 80) units for positioning and communication configuration with external units is modular through the units named above being switchable with one another with a simple turn of the hand via an included connection interface (15, 16, 17, 18) for introducing a new type of application and is controlled by continuously changeable user variables that are sent as packets, whereby the variables consist of alphanumeric symbols where each symbol has its equivalent in a binary code for digital communication, whereby the configuration of the modular transponder (90) is determined by a data or text message sent as a packet from an external communication arrangement and that allows the transponder (90) to be manufactured and sold without its specific function being configured and adapted to the customer, and whereby the process control unit (12) uses the digital equivalents of the alphanumeric symbols for configuring the transponder (90).

2. Method according to claim 1 characterized in that one application unit is an I/O unit (20) for analog/digital communication with external units (10, 20, 30, 40, 50, 60, 70, 80).

3. Method according to any of claims 1-2 characterized in that one application unit is a Battery unit (40) that can include a microphone and a loudspeaker.

4. Method according to claim 3 characterized in that one application unit is a Charging cable unit (70) for connecting to the Battery unit (40) and an external battery charger.

5. Method according to any of claims 1-4 characterized in that one application unit is an Audio cable unit (50) that connects to an audio connection (16) included in the Main unit (10), as well as to one of the units for I/O (20) and battery (40).

6. Method according to any of claims 1-5 characterized in that one application unit is a Serial unit (30) for adapting between CMOS voltage levels and RS232 voltage levels.

7. Method according to any of claims 1-6 characterized in that one application unit is a Power supply cable unit (60) for earth and direct current.

8. Method according to any of claims 1-7 characterized in that one application unit is a Cable connecting unit (80) for connecting the said units (10, 20, 30, 40, 50, 60, 70, 80) to a common data buss via a buss-input connection included in the units.

9. Method according to any of claims 1-8 characterized in that the satellite positioning unit is a Global Positioning System unit or similar and the mobile communications unit is a unit (14) that communicates via GSM or similar cellular mobile telecommunication system, plus that the data-text message is sent via GSM data respectively Short Message Services or similar.

10. Method according to any of claims 1-9 characterized in that the transponder (90) includes an IP-stack, which allows the transponder (90) to function as a web server for direct communication with an open network for data and telecommunication.

11. Method according to any of claims 1-10 characterized in that the transponder (90) has a memory unit for logging positional data, whereby the transponder can, via the data or text message, be configured for the static storage in memory of positional data in freely chosen time intervals and numbers of positions, whereby the transponder is triggered to transmit all stored positional data to an external unit for reporting positional data when the capacity for memory is fully utilized, and whereby this is repeated every time the memory is fully utilized.

12. Method according to any of claims 1-11 characterized in that the transponder (90) has a memory unit for logging positional data, whereby the transponder can, via the data or text message, be configured for the continual storage in memory of a number of positions, whereby the transponder replaces the stored positioning data in the memory unit according to the FIFO principle in order to download the last known positions to an external communications device when requested to do so.

13. Method according to any of claims 1-12 characterized in that in one embodiment of the invention, positional reporting to an external communication device is achieved when the satellite positioning unit (12) looses the receipt of signals for positioning during a specific unit of time configured by the user, whereby positioning continues when the satellite positioning unit resumes receipt of the signal.

14. Method according to any of claims 1-13 characterized in that the transponder (90) is initiated to external positional reporting via the NMEA protocol or similar protocol when one of the parameters longitude/latitude, direction or speed exceeds or reaches a configured value predetermined by the user.

15. Modular transponder (90) with dynamic control of functions for positioning objects, whereby a Main Unit (10) for positioning consists of a satellite-positioning and process control unit (12), a cellular mobile communications unit (14) plus a hardware interface for communicating with other connected application units (10, 20, 30, 40, 50, 60, 70, 80) characterized in that it also includes:
modularity through the units (10, 20, 30, 40, 50, 60, 70, 80) named above being switchable with one another via an included connection interface (15, 16, 17, 18) with a simple turn of the hand for introducing a new type of application;
a means of receiving in a mobile communciation unit (14) for receieving control commands regarding the way of working of the connected units (10, 20, 30, 40, 50, 60, 70, 80), which include user variables that can be continuously changed by the user and that are received as packets sent as data or text messages from an external communciations device, whereby the variables consist of alphanumeric symbols where each symbol has its equivalent in a binary code for digital communication;
an interface means for transforming the received alphanumeric symbols to their binary equivalents, which is equivalent to a configuration code that the controlling processor (12) uses to control the configuration of the units (10, 20, 30, 40, 50, 60, 70, 80) in the transponder (90) and;
that allows the transponder (90) to be manufactured and sold without its specific function being configured and adapted to the customer, whereby a user configures the specific function by sending a data or text message to the transponder (90) with the external communication device.

16. Modular transponder according to claim 15 characterized in that one application unit is an I/O unit (20) for analog/digital communication with external units.

17. Modular transponder according to any of claims 15-16 characterized in that one application unit is a Battery unit (40) that can include a microphone and a loudspeaker.

18. Modular transponder according to claim 17 characterized in that one application unit is a Charging cable unit (70) for connecting to the Battery unit (40) and an external battery charger.

19. Modular transponder according to any of claims 15-18 characterized in that one application unit is an Audio cable unit (50) that connects to an audio connection (16) included in the Main unit (10), as well as to one of the units for I/O (20) and battery (40).

20. Modular transponder according to any of claims 15-19 characterized in that one application unit is a Serial unit (30) for adapting between CMOS voltage levels and RS232 voltage levels.

21. Modular transponder according to any of claims 15-20 characterized in that one application unit is a Power supply cable unit (60) for earth and direct current.

22. Modular transponder according to any of claims 15-21 characterized in that one application unit is a Cable connecting unit (80) for connecting the said units to a common data buss via a buss-input connection included in the units.

23. Modular transponder according to any of claims 15-22 characterized in that the satellite positioning unit (12) is a Global Positioning System unit or similar and the mobile communication unit is a unit that communicates via GSM or similar cellular mobile telecommunications system (14), plus that the data-text message is sent via GSM data respectively Short Message Services or similar.

24. Modular transponder according to any of claims 15-23 characterized in that the transponder (90) has a memory unit for logging positional data, whereby the transponder can, via the data or text message, be configured for the static storage in memory of positional data in freely chosen time intervals and numbers of positions, whereby the transponder is triggered to transmit all stored positional data to an external unit for reporting positional data when the capacity for memory is fully utilized, and whereby this is repeated every time the memory is fully utilized.

25. Modular transponder according to any of claims 15-23 characterized in that the transponder (90) has a memory unit for logging positional data, whereby the transponder can, via the data or text message, be configured for the continual storage in memory of a number of positions, whereby the transponder replaces the stored positioning data in the memory unit according to the FIFO principle in order to download the last known positions to an external communication device when requested to do so.

26. Modular transponder according to any of claims 15-25 characterized in that in one embodiment of the invention, positional reporting to an external device is achieved when the satellite positioning unit (12) looses the receipt of signals for positioning during a specific unit of time configured by the user, whereby positioning continues when the satellite positioning unit resumes receipt of the signal.

27. Modular transponder according to any of claims 15-26 characterized in that the transponder (90) is initiated to external positional reporting via the NMEA protocol or similar protocol when one of the parameters longitude/latitude, direction or speed exceeds or reaches a configured value predetermined by the user.

28. Modular transponder according to any of claims 15-27 characterized in that the transponder (90) includes an IP-stack, which allows the transponder to function as a web server for direct communication with an open network for data and telecommunication.
